(19) United States
(12) Patent Application Publication
(10) Pub. No.: US 2024/0067116 A1
(43) Pub. Date: Feb. 29, 2024

(54) Capacitor Charging Circuit, Airbag Controller and Airbag System

(71) Applicant: Robert Bosch GmbH, Stuttgart (DE)

(72) Inventor: Xiaofei Qiu, Jiangsu (CN)

(21) Appl. No.: 18/259,553

(22) PCT Filed: Jan. 3, 2022
(86) PCT No.: PCT/EP2022/050008

§ 371 Date: Jun. 27, 2023

(30) Foreign Application Priority Data
Jan. 4, 2021 (CN) 2021 2000 7519.8

(51) Int. Cl. B60R 21/017; B60R 21/0136; H02J 7/00; H02J 7/34

(52) U.S. Cl. CPC B60R 21/017; B60R 21/0136; H02J 7/0032; H02J 7/00712; H02J 7/345; B60R 2021/01286

(57) ABSTRACT

A capacitor charging circuit, comprising: a charging power supply, for outputting a charging voltage; a voltage comparison module, connected to the charging power supply, and configured to output a drive signal indicating charging upon judging that the charging voltage is higher than a preset threshold; a current adjustment module, connected to the voltage comparison module and the charging power supply separately, the charging current adjustment module receiving the drive signal and, upon receiving the drive signal indicating charging, causing the charging power supply to charge the capacitor with a maximum charging current. The present application enables adjustment of the charging current of the charging capacitor according to the power supply voltage, thus increasing the charging speed.

### PRIOR ART

### Technical Field

The present invention relates to the field of charging, in particular to a capacitor charging circuit; and the present invention further relates to an airbag controller and an airbag system.

### Background Art

At present, in the design of airbag (air bag) controller chipsets, the charging current for each energy reserve capacitor (ER) needs to be determined according to the worst operating conditions of the airbag, and this generally relies on the experience of the developer to determine the charging current and charging control strategy. The charging current of an energy reserve capacitor under software control generally rises quite slowly, and the charging time of the energy reserve capacitor is consequently very long. It is thus hoped that these problems in the prior art can be mitigated.

### SUMMARY OF THE UTILITY MODEL

An object of the present utility model is to overcome the abovementioned shortcomings, to solve the problem of long charging times for energy reserve capacitors in the prior art. The present utility model is realized through the following solution:

A capacitor charging circuit is provided, comprising:
a charging power supply, for outputting a charging voltage;
a voltage comparison module, connected to the charging power supply, and configured to output a drive signal indicating charging upon judging that the charging voltage is higher than a preset threshold;
a current adjustment module, connected to the voltage comparison module and the charging power supply separately, the charging current adjustment module receiving the drive signal and, upon receiving the drive signal indicating charging, causing the charging power supply to charge the capacitor with a maximum charging current.

Furthermore, the capacitor charging circuit comprises: a reference voltage source, for outputting a preset reference voltage; the voltage comparison module being connected to the reference voltage source, the voltage comparison module comparing an acquired sample voltage of the charging power supply with the reference voltage, and the voltage comparison module judging that the charging voltage is higher than a preset threshold when the sample voltage is higher than the reference voltage.

Furthermore, the voltage comparison module comprises: a voltage feedback unit, connected to the charging power supply and configured to acquire the sample voltage of the charging power supply; a comparison unit, connected to the reference voltage source and the voltage feedback unit separately, the comparison unit comparing the received reference voltage with the sample voltage, and outputting the drive signal indicating charging when the sample voltage is higher than the reference voltage.

Furthermore, the comparison unit is a voltage comparator, and the voltage comparison module is configured to output a drive signal indicating no charging upon judging that the charging voltage is lower than a preset threshold.

Furthermore, the voltage feedback unit comprises a first voltage-dividing resistor and a second voltage-dividing resistor which are connected to the charging power supply in series, and a voltage is acquired from between the first voltage-dividing resistor and the second voltage-dividing resistor as the sample voltage; and an inverting input of the voltage comparator is connected to the reference voltage, a non-inverting input of the voltage comparator is connected to the sample voltage, and an output of the voltage comparator represents the drive signal.

Furthermore, the charging current adjustment module comprises: a drive unit, connected to the voltage comparator and receiving the drive signal, and outputting a drive voltage according to the drive signal; a current adjustment unit, connected between the charging power supply and the capacitor and connected to the drive unit, wherein the drive voltage causes the charging power supply to charge the capacitor with the maximum charging current when the drive signal indicates charging, or the drive voltage causes the charging power supply to cut off power to the capacitor when the drive signal indicates no charging.

Furthermore, the current adjustment unit is a metal-oxide-semiconductor field-effect transistor, a gate of the metal-oxide-semiconductor field-effect transistor being connected to the drive unit, a source of the metal-oxide-semiconductor field-effect transistor being connected to the charging power supply, a drain of the metal-oxide-semiconductor field-effect transistor being connected to a charging end of the capacitor, and another end of the capacitor being connected to ground; and when the drive voltage outputted by the drive unit is greater than or equal than an operating voltage of the metal-oxide-semiconductor field-effect transistor, the source and drain of the metal-oxide-semiconductor field-effect transistor are turned on, and the charging power supply charges the capacitor with a maximum output current.

Furthermore, the reference voltage source is a divided voltage of an output charging voltage of the charging power supply.

According to another aspect of the present utility model, an airbag controller is further provided, having an energy reserve capacitor, wherein the capacitor charging circuit as claimed in claim 8 is provided in the airbag controller, the capacitor charging circuit being configured to charge the energy reserve capacitor.

According to another aspect of the present utility model, an airbag system is further provided, characterized in that the airbag system comprises an airbag, a gas generator, a sensor and the airbag controller as claimed in claim 9, the airbag controller being electrically connected to the sensor and the gas generator separately, and the gas generator being connected to the airbag; upon detecting a collision event, the sensor sends an airbag inflation instruction to the airbag controller; in response to the inflation instruction, the airbag controller sends an inflation activation instruction to the gas generator and supplies an operating voltage to the gas generator; and in response to the inflation activation instruction, the gas generator inflates the airbag.

In the capacitor charging circuit provided in the solution of the present utility model, providing the voltage comparison module and the charging current adjustment unit makes it possible to adjust the charging current of the charging capacitor according to the power supply voltage, so that the charging current adjustment unit charges the charging capacitor with the maximum output current of the charging power supply; thus, control of the charging current can be achieved without the need for a remote control signal, and the charging efficiency of the charging capacitor is thereby improved.

### BRIEF DESCRIPTION OF THE DRAWINGS

The features, characteristics, advantages and benefits of the present invention will become obvious through the following detailed description in conjunction with the drawings.

FIG. 1 is a schematic block diagram of a capacitor charging circuit in an embodiment of the present application.

FIG. 2 is an example based on the capacitor charging circuit in FIG. 1.

### DETAILED DESCRIPTION OF EMBODIMENTS

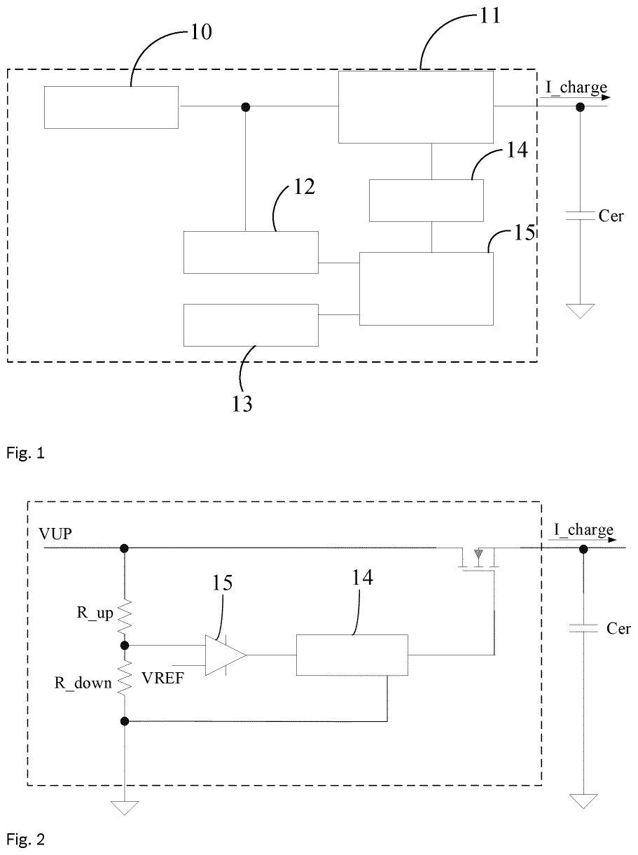

The technical solution in embodiments of the present utility model is explained in detail below in conjunction with FIGS. 1-2.

FIG. 1 is a schematic block diagram of a capacitor charging circuit in an embodiment of the present application; a charging capacitor Cer in this embodiment is a multi-layer ceramic capacitor (MLCC). As shown in the figure, the capacitor charging circuit comprises a charging power supply 10, a voltage comparison module, a reference voltage source 13, a current adjustment module and the charging capacitor Cer. The voltage comparison module is connected to the charging power supply 10, and is configured to output a drive signal indicating charging upon judging that the charging voltage is higher than a preset threshold, to charge the charging capacitor Cer, a charging current being I_charge. The voltage comparison module comprises a comparison unit 15 and a voltage feedback unit 12; the current adjustment module comprises a drive unit 14 and a charging current adjustment unit 11. Specifically, the charging power supply 10 is configured to output a charging voltage; the voltage feedback unit 12 acquires a sample voltage of the charging power supply 10 and outputs the sample voltage to the comparison unit 15. The comparison unit 15 compares the sample voltage with a preset reference voltage outputted by the reference voltage source 13; when the sample voltage is higher than the reference voltage, the comparison unit 15 judges that the charging voltage is higher than a preset threshold, and outputs to the drive unit 14 a drive signal indicating charging. The drive unit 14 is configured to output a drive voltage to the charging current adjustment unit 11 according to the drive signal. At the same time, if the voltage comparison module judges that the charging voltage is lower than a preset threshold, the voltage comparison module outputs a drive signal indicating no charging. The current adjustment unit 11 is arranged between the charging power supply 10 and the charging capacitor Cer; the charging current adjustment unit 11 adjusts the charging current for the charging capacitor Cer according to the drive voltage, using the maximum charging current that the circuit is capable of carrying to charge the charging capacitor Cer. Alternatively, when the drive signal indicates no charging, the drive voltage signal causes the charging power supply to cut off power to the charging capacitor.

Referring to FIG. 2, FIG. 2 is an example based on the capacitor charging circuit in FIG. 1. As shown in the figure, the voltage feedback unit 12 comprises a first voltage-dividing resistor R_up and a second voltage-dividing resistor R_down, the first voltage-dividing resistor R_up and second voltage-dividing resistor R_down being connected to the charging power supply VUP in series; once the first voltage-dividing resistor R_up and second voltage-dividing resistor R_down have been connected to the charging power supply VUP, the charging power supply 10 is subjected to voltage division by means of the first voltage-dividing resistor R_up and second voltage-dividing resistor R_down, and a voltage is acquired from between the first voltage-dividing resistor R_up and the second voltage-dividing resistor R_down as the sample voltage. The comparison unit 15 then compares the sample voltage with a reference voltage VREF and controls the drive unit 14 in order to control an operating state of the charging current adjustment unit 11. In this embodiment, the preset reference voltage VREF is set to be lower than a voltage-divided voltage on the first voltage-dividing resistor R_up acquired by the comparison unit 15, therefore, when the comparison unit 15 judges that the sample voltage is higher than the reference voltage, the comparison unit 15 outputs a drive signal, and the drive unit 14 receives the drive signal and outputs a drive voltage to the charging current adjustment unit 11; the drive voltage switches on the charging current adjustment unit 11, and causes the charging power supply 10 to charge the charging capacitor Cer with the maximum charging current, and it is thus possible to increase the charging efficiency of the charging capacitor. In this embodiment, the reference voltage source may also be a divided voltage of an output voltage of the charging power supply.

In this embodiment, the charging current adjustment unit 11 may be a metal-oxide-semiconductor field-effect transistor (MOSFET); as shown in FIG. 2, the gate of the MOSFET is connected to the drive unit 14, the source of the MOS FET is connected to the charging power supply VUP, the drain of the MOS FET is connected to a charging end of the capacitor Cer, and another end of the capacitor Cer is connected to ground.

Furthermore, the comparison unit 15 is a voltage comparator; an inverting input of the voltage comparator is connected to the reference voltage source 13, a non-inverting input of the voltage comparator is connected to the sample voltage, and an output of the voltage comparator represents the drive signal. The comparison unit 15 compares the sample voltage with the preset reference voltage outputted by the reference voltage source 13, and outputs the drive signal indicating charging to the drive unit 14 upon judging that the sample voltage is higher than the reference voltage. In this embodiment, upon determining that the sample voltage is lower than the reference voltage, the comparison unit 15 outputs the drive signal for the source and drain of the MOS FET to the drive unit 14, and the drive unit 14 outputs the drive voltage to the charging current adjustment unit 11 according to the drive signal. The MOS FET is arranged between the charging power supply VUP and the charging capacitor Cer; the MOS FET turns on, and the charging capacitor Cer is charged by the maximum current that the circuit is capable of carrying.

In addition, in this embodiment, when charging of the charging capacitor Cer is complete, i.e. when it has been charged to saturation, the charging current will fall all the way to zero, at which time the power supply voltage VUP and the capacitor voltage are equal. At the same time, the sample voltage will also experience an increase, returning to an initial state which it was in when charging began. At this time, the MOS FET is still ON, but has no charging current, and this situation will continue until the next charging cycle.

The capacitor charging circuit in this embodiment is suitable for use in an application specific integrated circuit (ASIC), but the ASIC may also be replaced by a field programmable gate array (FPGA), a programmable logic device (PLD) or a complex programmable logic device (CPLD), etc.

The ASIC containing the capacitor charging circuit of this embodiment is used in a control unit (electronic control unit, ECU) of an airbag in a vehicle, and the airbag control unit is used in an airbag control system, which comprises an airbag, a gas generator, a sensor and the airbag controller in the embodiment described above; the capacitor charging circuit in the embodiment above is provided in the airbag controller, the sensor is electrically connected to the airbag controller, the gas generator is electrically connected to the airbag controller, and the gas generator is connected to the airbag. When the sensor detects a collision event, the sensor sends an airbag inflation instruction to the airbag controller; in response to the inflation instruction, the airbag controller sends an inflation activation instruction to the gas generator and supplies an operating voltage to the gas generator; and in response to the inflation activation instruction, the gas generator inflates the airbag.

In this embodiment, providing the voltage feedback unit 12, the comparison unit 15, the drive unit 14 and the charging current adjustment unit 11 makes it possible to adjust the charging current of the charging capacitor Cer according to the power supply voltage, so that the charging current adjustment unit 11 can charge the charging capacitor Cer with the maximum output current of the charging power supply; thus, control of the charging current can be achieved without the need for a remote control signal, and the charging efficiency of the charging capacitor Cer is thereby improved.

All of the functional units in embodiments of the present utility model may be integrated in one processing unit, or each unit may independently serve as one unit, or two or more units may be integrated in one unit; such integrated units may be implemented in the form of hardware, or in the form of hardware-plus-software functional units.

Those skilled in the art could still amend and replace various details without deviating from the substance and scope of the present utility model. The scope of protection of the present utility model is defined by the claims alone.

1. A capacitor charging circuit, comprising:
a charging power supply configured to output a charging voltage;
a voltage comparison module, connected to the charging power supply, and configured to output a drive signal indicating charging upon determining that the charging voltage is higher than a preset threshold; and
a current adjustment module, connected to the voltage comparison module and the charging power supply separately, the charging current adjustment module being configured to (i) receive the drive signal, and (ii) cause the charging power supply to charge the capacitor with a maximum charging current in response to receiving the drive signal indicating charging.

2. The capacitor charging circuit as claimed in claim 1, further comprising a reference voltage source configured to output a preset reference voltage, wherein:
the voltage comparison module is connected to the reference voltage source,
the voltage comparison module is configured to compare an acquired sample voltage of the charging power supply with the reference voltage, and
the voltage comparison module determines that the charging voltage is higher than a preset threshold when the sample voltage is higher than the reference voltage.

3. The capacitor charging circuit as claimed in claim 2, wherein the voltage comparison module comprises:
a voltage feedback unit connected to the charging power supply and configured to acquire the sample voltage of the charging power supply; and
a comparison unit, connected to the reference voltage source and the voltage feedback unit separately, the comparison unit being configured to (i) compare the received reference voltage with the sample voltage, and (ii) output the drive signal indicating charging when the sample voltage is higher than the reference voltage.

4. The capacitor charging circuit as claimed in claim 3, wherein:
the comparison unit is a voltage comparator, and
the voltage comparison module is configured to output a drive signal indicating no charging upon determining that the charging voltage is lower than a preset threshold.

5. The capacitor charging circuit as claimed in claim 4, wherein:
the voltage feedback unit comprises a first voltage-dividing resistor and a second voltage-dividing resistor which are connected to the charging power supply in series, and a voltage is acquired from between the first voltage-dividing resistor and the second voltage-dividing resistor as the sample voltage; and
an inverting input of the voltage comparator is connected to the reference voltage, a non-inverting input of the voltage comparator is connected to the sample voltage, and an output of the voltage comparator represents the drive signal.

6. The capacitor charging circuit as claimed in claim 5, wherein the charging current adjustment module comprises:
a drive unit, connected to the voltage comparator, and configured to (i) receive the drive signal, and (ii) output a drive voltage according to the drive signal; and
a current adjustment unit, connected between the charging power supply and the capacitor and connected to the drive unit, wherein the drive voltage causes the charging power supply to charge the capacitor with the maximum charging current when the drive signal indicates charging, or the drive voltage causes the charging power supply to cut off power to the capacitor when the drive signal indicates no charging.

7. The capacitor charging circuit as claimed in claim 6, wherein:
the current adjustment unit is a metal-oxide-semiconductor field-effect transistor, a gate of the metal-oxide-semiconductor field-effect transistor being connected to the drive unit, a source of the metal-oxide-semiconductor field-effect transistor being connected to the charging power supply, a drain of the metal-oxide-semiconductor field-effect transistor being connected to a charging end of the capacitor, and another end of the capacitor being connected to ground; and
when the drive voltage outputted by the drive unit is greater than or equal than an operating voltage of the metal-oxide-semiconductor field-effect transistor, the source and drain of the metal-oxide-semiconductor field-effect transistor are turned on, and the charging power supply charges the capacitor with a maximum output current.

8. The capacitor charging circuit as claimed in claim 1, wherein the reference voltage source is a divided voltage of an output charging voltage of the charging power supply.

9. An airbag controller having an energy reserve capacitor, wherein:
the capacitor charging circuit as claimed in claim 8 is provided in the airbag controller, and
the capacitor charging circuit is configured to charge the energy reserve capacitor.

10. An airbag system, comprising:
an airbag,
a gas generator,
a sensor, and
the airbag controller as claimed in claim 9,
wherein the airbag controller is electrically connected to the sensor and the gas generator separately,
wherein the gas generator is connected to the airbag,
wherein, upon detecting a collision event, the sensor sends an airbag inflation instruction to the airbag controller,
wherein, in response to the inflation instruction, the airbag controller sends an inflation activation instruction to the gas generator and supplies an operating voltage to the gas generator, and
wherein, in response to the inflation activation instruction, the gas generator inflates the airbag.
